(19) United States
(12) Patent Application Publication
(10) Pub. No.: US 2004/0061932 A1
(43) Pub. Date: Apr. 1, 2004

(54) Ophthalmic surgical microscope with a subject illumination system

(76) Inventors: Juergen Pensel, Altstaetten (CH); Ulrich Sander, Rebstein (CH)

Correspondence Address: HODGSON RUSS LLP, ONE M & T PLAZA, SUITE 2000, BUFFALO, NY, 14203-2391, US

(21) Appl. No.: 10/662,218

(22) Filed: Sep. 12, 2003

(30) Foreign Application Priority Data
Sep. 17, 2002 (DE) 102 42 983.9

(51) Int. Cl. G02B 21/00

(52) U.S. Cl. 359/368

(57) ABSTRACT

An ophthalmic surgical microscope having an apparatus for illumination of a subject with illuminating light, in which the spectral selection and/or polarization and/or phase properties of the illuminating light are selected in such a way that the illuminating light is reflected, absorbed, and/or scattered differently in the different media of the patient's eye (5) and/or at the media interfaces. The light thus modified is coupled out of the observation beam path (2) of the stereomicroscope (1); the nature, shape, and position of the individual media and/or their interfaces are determined using an evaluation unit (14); and an electronically generated optical image is in turn coupled via a projector (16) or other display into the observation beam path (2).

### CROSS REFERENCE TO RELATED APPLICATIONS

This application claims priority of the German patent application 102 42 983.9 filed Sep. 17, 2002 which is incorporated by reference herein.

### FIELD OF THE INVENTION

The invention concerns an ophthalmic surgical microscope having a subject illumination system with special optical properties.

### BACKGROUND OF THE INVENTION

Many different types of illumination systems that are integrated into a surgical microscope are sufficiently known to one skilled in the art. These known illumination systems either are secured laterally to the microscope as an oblique illumination system, for example using a gooseneck (cf. WILD brochure “Oblique lamp,” M667d-VI.86, publication date June 1986); or, in order to decrease the illumination angle, are incorporated directly into the stereomicroscope, so that the illumination beam path is guided directly through the main objective (EP-B1-0 661 020). All these illumination systems have in common the fact that they use white light as the illuminating light. As a rule, halogen lamps are used as light sources. A spectral selection of the white light is usually made in order to protect the human eye from harmful radiation. This harmful radiation is usually absorbed using UV and IR filters.

In present-day cataract operations, it is necessary to see the rear lens capsule of the patient's eye, and lens residues remaining thereon, in high-contrast fashion with the microscope. The sufficiently known “red reflection” is used for this purpose. The red reflection is technically very difficult to produce using the so-called zero-degree or coaxial technique. These illumination systems can result in troublesome vignetting and reflections in the observation beam path.

Because of the way in which the red reflection is produced, it depends greatly on the individual patient's eye and reacts very sensitively to movements of the eye. In addition, the manner in which the red reflection is produced means that the observer in the assistant's observation beam path sees a different red reflection than the observer in the main beam path.

These disadvantages can be compensated for by a suitable illumination arrangement in the microscope, cf. the Leica brochure “The Leica Imaging Module,” document no. 10 M1 410 Ide-X.99.RDV, printed October 1999.

It is furthermore known from the existing art that in laboratory microscopes, polarization filters and/or phase filters and/or color filters are used during visual observation in order to make subject structures more visible, cf. K. Michel, “Die Grundzüge der Theorie des Mikroskops” [Fundamentals of microscope theory], Stuttgart 1981. The phase contrast technique has hitherto been applied exclusively to monoscopic microscopes.

As a further improvement, it is known that pre-operative stains are applied to various media of the human eye in order to make those media visible, cf. the “Vision Blue” stain of Medizintechnik-Vertrieb-GmbH, Mömbris.

Stains of individual media in vivo in the patient's eye are problematic in that because of poor perfusion of the optical eye media, they must be performed invasively and a long time prior to surgery, are poorly selective, and moreover can change in the course of the operation. This process results in additional stress on the patient's eye. Preoperative stains can be only inadequately controlled during the operation, so that it is not possible, for different phases of the operation, to place emphasis on different media or media interfaces in the eye in terms of visibility through the microscope.

### SUMMARY OF THE INVENTION

It is thus the object of the invention to find a solution to these problems and to improve the visibility of the various layers and media in the eye.

This object is achieved by way of an illumination system for an ophthalmic surgical microscope which allows the individual media in the eye and/or the individual interfaces between the media to be recognized and distinguished, without the aforesaid disadvantages of methods used today, such as the red reflection or preoperative staining.

The basis of the invention is the fact, known from physics, that light having different optical properties (spectrum and/or polarization and/or phase) is reflected, absorbed, or scattered differently in individual media and/or at their interfaces. The reasons for this are the differing physico-chemical compositions and different morphologies of these media. According to the present invention, this physical effect is exploited in the following fashion.

By means of the illumination system according to the present invention, light having special optical properties is generated. This can be accomplished on the one hand by spectral selection of the white light, on the other hand by way of a differing polarization or phase of the light, or by a combination of these factors. These optical properties of the illuminating light can be achieved in various ways. In one embodiment, color filters and/or polarization filters which modify the light in the desired fashion are introduced in front of a light source. In another embodiment, illumination light sources already having the desired spectral properties are used. Such light sources are, for example, gas discharge lamps.

This illuminating light having selected optical properties, in particular also in the non-visible region, is coupled into an illumination beam path of the microscope in a manner sufficiently known, using a deflection element for the such as a mirror or prism. The illumination light then directed through the objective lens of the microscope and onto a patient's eye. Because of the aforementioned physico-chemical properties, the various media in the patient's eye cause a differing reflection, absorption, scattering, or other interactions of the illuminating light at the individual media and/or at their interfaces.

The light thus modified is coupled out of observation beam path of the microscope using a semitransparent deflection element, for example a mirror or prism. Known optical splitters are used for this purpose. The light is then conveyed to a sensor capable of detecting the light that has been differently modified in the various media of the eye and/or at their interfaces, and converting it into corresponding electronic signals.

These signals are directed to an evaluation unit, for example a computer, which is capable of evaluating the incoming signals in terms of their modification and generating a driver signal for a projector or a monitor or other display. On the basis of this driver signal, the projector, monitor, or display generates an electronically produced optical image. The optical image is coupled via a known deflection element into the observation beam path of the microscope, and selectably overlaid on the image of the subject visible directly through the microscope.

For a stereoscopic data superimposition such as the one known, for example, from EP-B1-1 008 005, two separate deflection elements and two separate sensors are required for the right and left images, with two corresponding deflection elements in the right and left observation beam paths of the stereomicroscope. Methods for data superimposition are known, cf. the aforementioned Leica brochure “The Leica Imaging Module.”

Hitherto, however, it has always been images generated by outside units such as endoscopes, computers, or video cameras that were reflected in using data superimposition systems.

According to the invention described here, however, the image reflected into the microscope is one that was acquired by that same microscope but was modified in terms of its image content.

By suitable selection of the position of the superimposed image (position and configuration of the intermediate image in the eyepiece [not depicted]), it can be overlaid in direct and accurately fitted fashion onto the image of the patient's eye optically generated directly by the microscope.

According to an embodiment, additional shutters are incorporated into the observation beam path of the microscope or into the beam path of the reflected-in image and make it possible to see, selectably, the original microscope image, the modified reflected-in image from the display, or an overlay of the two images. True-color, false-color, or black-and-white systems can be used, for example, as projector 16 or the monitor or other display.

Any desired combinations of spectral selection, polarization, and/or phase of the illuminating light, and any combinations of true-color, false-color, and black-and-white projection, are to be selected in order to achieve the aforesaid optical effects. In extreme cases, it is also possible to work exclusively with “false-color light” in order to protect the patient's and the observer's eyes.

As a simplified variant, a comparable visualization according to the present invention of the nature, shape, and position of individual media of the patient's eye and/or their interfaces can be achieved on a purely visual basis, even without reflection in and out and electronic processing, if the modification of the illuminating light is accomplished in the visible region. For that purpose, filters are introduced into the illumination system and at a suitable location between the magnification system and eyepieces of the stereomicroscope, and create the desired spectral selection and thus make visible the structure of the media being observed.

### BRIEF DESCRIPTION OF THE DRAWINGS

The invention will be explained in more detail, symbolically and by way of example, with reference to the lone Figure.

FIG. 1 is a schematic diagram of an ophthalmic surgical stereomicroscope formed in accordance with the present invention.

### DETAILED DESCRIPTION OF THE INVENTION

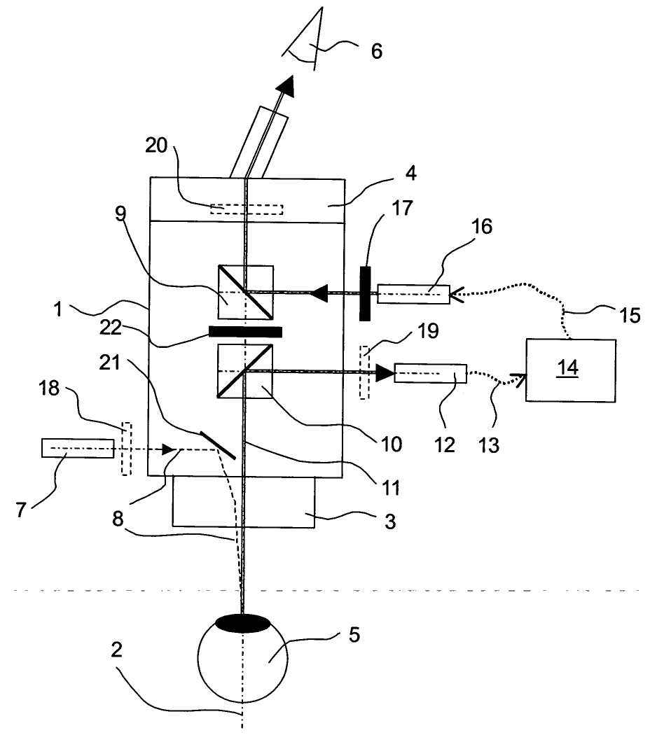

FIG. 1 depicts a stereomicroscope 1 having a magnification system, a pair of observation beam paths 2 (only one of which is visible in FIG. 1), an objective 3, and a tube 4 with eyepieces. FIG. 1 also depicts a patient's eye 5 and an observer 6. For simplicity's sake, the second observation beam path of stereomicroscope 1 is not depicted in the drawing, since it lies behind observation beam path 2 in the view of FIG. 1. According to the present invention, the illumination system integrated into stereomicroscope 1, and the system for imaging patient's eye 5, are configured as follows.

A light source 7 is mounted on stereomicroscope 1. The light generated by this light source 7 is directed, through an insertable filter 18 for the illumination system, onto a deflection element 21 and from there projected onto patient's eye 5. The illuminating light modified and reflected by patient's eye 5 is coupled by means of a deflection element 10 out of observation beam path 2 of stereomicroscope 1 and directed, through selectably insertable optical filters 19 for a light-sensitive sensor 12, onto the sensor. Sensor 12 detects the light reflected from patient's eye 5 in terms of nature, shape, and position, and converts it into electronic signals 13.

These signals 13 are converted using an evaluation unit 14, for example a computer, into driver signals 15 for a projector 16, and delivered to the projector. Projector 16 generates, from driver signals 15 conveyed to it, an optical image which is coupled by means of a deflection element 9 into observation beam path 2 of stereomicroscope 1. The incoupled image is overlaid selectably, using shutters 17 and 22, onto the optical image of patient's eye 5 generated directly by stereomicroscope 1.

It is further evident from the drawings that shutter 22 is mounted between the two deflection elements 9 and 10 in observation beam path 2 of stereomicroscope 1. Shutter 17 is mounted in the beam path of the optical image generated by projector 16. Using these shutters 17 and 22, a variety of overlay combinations of the image of patient's eye 5 optically generated directly by stereomicroscope 1, and the optical image generated by projector 16, can be produced.

With the aid of a calibration apparatus, evaluation unit 14 is capable of congruently overlaying the image that is to be coupled in, in terms of its position and size, onto the image of patient's eye 5 optically generated directly by stereomicroscope 1. This allows the position, shape, and size of the various media and interfaces of patient's eye 5 to be easily recognized.

As a simplified variant, a comparable visualization according to the present invention of the nature, shape, and position of individual media and/or interfaces of patient's eye 5 can be achieved on a purely visual basis, without reflection in and out and electronic processing, if the desired modifications of the illuminating light are performed in the visible region. For that purpose, filters 18 are inserted into illumination beam path 8 and at a suitable location between the magnification system (not depicted) and the eyepieces of tube 4 (cf. filter 20).

In this simplified variant, an observing assistant (not depicted in the drawings) receives the same image as the principal observer, with the improved depiction of the media and/or their interfaces of patient's eye 5, if additional filters are correspondingly inserted in the assistant tube in front of the eyepieces. The following improvements in terms of conventional systems and methods are thereby achieved

The individual media of the human eye and/or their interfaces are made visible to the surgeon correctly and in a manner conforming to the original in terms of nature, shape, and position. The surgeon moreover has the ability, by suitable selection of the optical properties of the illuminating light (spectral selection, polarization, and/or phase and/or subsequent image processing), to emphasize or suppress elements of the eye that he or she specifically desires, for example the lens. With this new method, in contrast to observation using the red reflection, the visibility of the media and/or interfaces being viewed is independent of movement of the patient's eye.

The invention is not limited solely to ophthalmic surgical microscopes, but rather can also be used in other optical instruments, for example stereomicroscopes, slit lamps, binocular magnifiers, chemical analytical devices, or other optical viewing devices with illumination.

Parts List

| | |
|---|---|
| 1 | Stereomicroscope having a magnification system |
| 2 | Observation beam path of (1) |
| 3 | Objective |
| 4 | Tube with eyepieces |
| 5 | Patient's eye |
| 6 | Observer |
| 7 | Light source (s) |
| 8 | Beam path of illuminating light |
| 9 | Deflection element |
| 10 | Deflection element |
| 11 | Reflected illuminating light |
| 12 | Sensor |
| 13 | Electrical signal from (12) |
| 14 | Evaluation unit (computer) |
| 15 | Driver signal for (16) |
| 16 | Projector |
| 17 | Shutter |
| 18 | Color filter and/or polarization filter (insertable) for illumination |
| 19 | Filter (insertable) for (12) |
| 20 | Filter (insertable) for direct observation |
| 21 | Deflection element for illumination |
| 22 | Shutter |

What is claimed is:

1. An ophthalmic surgical microscope comprising:
at least one observation beam path for intersecting with a patient's eye being viewed through the microscope; and
an apparatus for illumination of the patient's eye with illuminating light, wherein the apparatus includes means for selecting at least one of the spectral band, polarization, and phase of the illuminating light such that the illuminating light is reflected, absorbed, or scattered differently in different media of the patient's eye or at interfaces of different media of the patient's eye.

2. The ophthalmic surgical microscope as defined in claim 1, further comprising:
a display for generating an optical display image in response to a driver signal received by the display;
a first deflection element arranged in the observation beam path for diverting illuminating light reflected from the patient's eye out of the observation beam path;
a sensor arranged to receive light diverted by the first deflection element, the sensor generating a sensor signal representative of the light received thereby;
an evaluation unit connected to the sensor and to the display, the evaluation unit receiving and-processing the-sensor signal to-provide a driver signal for the display, whereby the display generates an optical display image of the patient's eye; and
a second deflection element arranged in the observation beam path for reflecting the display image of the patient's eye into the observation beam path.

3. The ophthalmic surgical microscope as defined in claim 2, wherein the ophthalmic surgical microscope is a stereomicroscope having a pair of observation beam paths, two of the first deflection element are provided and allocated one to each of the pair of observation beam paths, and two of the second deflection element are provided and allocated one to each of the pair of observation beam paths.

4. The ophthalmic surgical microscope as defined claim 2, wherein the display generates a true-color image.

5. The ophthalmic surgical microscope as defined claim 2, wherein the display generates a false-color image.

6. The ophthalmic surgical microscope as defined claim 2, wherein the display generates a black-and-white image.

7. The ophthalmic surgical microscope as defined in claim 1, wherein the apparatus for illumination of the patient's eye includes at least one light source emitting illuminating light characterized by a specified spectral band, polarization, and/or phase.

8. The ophthalmic surgical microscope as defined in claim 1, wherein the apparatus for illumination of the patient's eye includes a light source and at least one filter selectably insertable after the light source for producing certain optical properties in the illuminating light.

9. The ophthalmic surgical microscope as defined in claim 1, wherein the apparatus for illumination of the patient's eye includes a light source selected from the following group: coherent light source, incoherent light source, laser, diode, and lamp.

10. The ophthalmic surgical microscope as defined in claim 2, further comprising a shutter in the observation beam path, the shutter being operable to selectively block direct observation light from the patient's eye.

11. The ophthalmic surgical microscope as defined in claim 2, further comprising a shutter between the display and the second deflection element, the shutter being operable to selectively block the display image of the patient's eye.

12. The ophthalmic surgical microscope as defined in claim 10, further comprising an additional shutter between the display and the second deflection element, the additional shutter being operable to selectively block the display image of the patient's eye.

13. The ophthalmic surgical microscope as defined in claim 1, further comprising a filter selectably insertable into the observation beam path for visualization of the different media of the patient's eye.

14. The ophthalmic surgical microscope as defined in claim 13, wherein the ophthalmic surgical microscope is a stereomicroscope having a pair of observation beam paths, and two filters are provided and allocated one to each of the pair of observation beam paths for visualization of the different media of the patient's eye
